(19) United States
(12) Patent Application Publication
(10) Pub. No.: US 2024/0409382 A1
(43) Pub. Date: Dec. 12, 2024

(54) DAMAGE DETECTION SYSTEM

(71) Applicant: THREE SMITH GROUP LIMITED, Elland, West Yorkshire (GB)

(72) Inventors: David Edgar, Elland, West Yorkshire (GB); Matthew Wroe, Elland, West Yorkshire (GB); Mark Bonner, Elland, West Yorkshire (GB)

(73) Assignee: THREE SMITH GROUP LIMITED, Elland, West Yorkshire (GB)

(21) Appl. No.: 18/701,859

(22) PCT Filed: Oct. 17, 2022
(86) PCT No.: PCT/GB2022/052638

§ 371 Date: Apr. 16, 2024

(30) Foreign Application Priority Data
Oct. 18, 2021 (GB) 2114848.1

(51) Int. Cl. B66F 17/00; G06T 7/00

(52) U.S. Cl. CPC B66F 17/003; G06T 7/001; G06T 2207/20081; G06T 2207/30252

(57) ABSTRACT

A damage detection system comprising a controller and a camera associated with a vehicle. The camera is configured to acquire images of the vicinity of the vehicle. The controller is configured to process the acquired images in order to: recognise a safety structure in the acquired images; compare the recognised safety structure in the acquired image with an other image of the same, or a corresponding, safety structure; and based on the comparison, provide a damage-status-signal that represents a damage status of the safety structure.

### FIELD

The present disclosure relates to a damage detection system, and in particular a damage detection system that processes images in order to detect damage to safety structures such as barriers, bollards and racking in warehouses.

### SUMMARY

According to a first aspect of the present disclosure, there is provided a damage detection system comprising:
a camera associated with a vehicle, wherein the camera is configured to acquire images of the vicinity of the vehicle;
a controller configured to process the acquired images in order to:
   recognise a safety structure in the acquired images;
   compare the recognised safety structure in the acquired image with an other image of the same, or a corresponding, safety structure; and
   based on the comparison, provide a damage-status-signal that represents a damage status of the safety structure.

Advantageously, such a damage detection system can automatically identify damage to a safety structure by simply processing images that are acquired as the vehicle passes by the safety structure.

The vehicle may be a forklift truck.

The system may further comprise a plurality of cameras, each configured to acquire images of the vicinity of the vehicle.

The controller may be configured to recognise the safety structure in the image by:
performing an object recognition operation on the image in order to recognise one or more predetermined safety structures in the image; or
applying a machine learning algorithm to the image in order to determine a classification of a safety structure as one that was visible in an image that was used as training data for training the machine learning algorithm.

The controller may be configured to compare the recognised safety structure in the image with the other image of the same, or a corresponding, safety structure by:
determining an identifier for the type of safety structure that is recognised in the image;
retrieving one or more images of the same type of safety structure from memory; and
comparing the recognised safety structure in the image with the one or more images of the same type of safety structure retrieved from memory.

The one or more images of the same type of safety structure retrieved from memory may comprise images of the safety structure in an undamaged state and/or one or more damaged states.

Comparing the recognised safety structure in the image with the one or more images of the same type of safety structure retrieved from memory may comprise determining a degree of similarity between the images. The controller may be configured to provide the damage-status-signal, that represents the damage status of the safety structure, based on the determined degree of similarity.

The controller may be configured to determine the identifier for the type of safety structure that is recognised in the image by reading a machine-readable code that is visible in the acquired image.

The controller may be configured to:
combine a plurality of images of the same safety structure into a combined-image; and
compare the combined-image with the other image of the same, or a corresponding, safety structure.

The controller may be configured to: combine the plurality of images of the same safety structure into a 3-dimensional combined-image.

The controller may be configured to:
determine the distance to the safety structure that is recognised in the image;
in response to the acquisition of subsequent images by the camera:
   recognise the safety structure in the subsequent image;
   determine a distance to the safety structure in the subsequent image;
   calculate if the distance to the safety structure is increasing or decreasing, and:
      if the determined distance is reducing, then identify the subsequent image as an approaching-image; and
      if the determined distance is increasing, then identify the subsequent image as a retreating-image;
compare the recognised safety structure in a retreating-image with the recognised safety structure in an approaching-image; and
based on the comparison, provide the damage-status-signal that represents the damage-status of the safety structure.

The system may further comprise an alert signal generator that is configured to selectively provide an alert based on the damage-status-signal.

The controller may be configured to:
determine the location of the safety structure that is recognised in the image; and
provide an alert that is based on the determined location of the safety structure.

The controller may be configured to trigger the camera to acquire the image: periodically;
in response to the vehicle having a predetermined location;
in response to receiving a proximity signal from a safety structure; and/or in response to an on-demand command provided by a user,

The controller may be configured to:
compare a colour of the recognised safety structure in the acquired image with a colour of the safety structure in the other image of the same, or a corresponding, safety structure; and
based on the comparison, provide a damage-status-signal that represents whether or not the safety structure is rusted.

According to a further aspect of the present disclosure, there is provided a controller configured to:
process images that are acquired by a camera associated with a vehicle;
recognise a safety structure in the acquired images;
compare the recognised safety structure in the acquired Image with an other image of the same, or a corresponding, safety structure; and
based on the comparison, provide a damage-status-signal that represents a damage status of the safety structure.

According to a further aspect of the present disclosure, there is provided a method of detecting damage to a safety structure, the method comprising:
acquiring images of the vicinity of a vehicle;
recognising a safety structure in the acquired images;
comparing the recognised safety structure in the acquired image with an other image of the same, or a corresponding, safety structure; and based on the comparison, providing a damage-status-signal that represents a damage status of the safety structure.

There may be provided a computer program, which when run on a computer, causes the computer to configure any apparatus, including a controller, system or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF THE DRAWINGS

One or more embodiments will now be described by way of example only with reference to the accompanying drawings in which:

FIG. 1 shows schematically a plan view of part of the inside of a warehouse, which is a suitable environment in which a damage detection system that is described herein can be used;

FIG. 2 shows an example embodiment of a damage detection system;

FIG. 3 shows another example embodiment of a damage detection system;

FIG. 4A shows schematically an image of an undamaged safety barrier;

FIG. 4B shows schematically an image of a damaged safety barrier;

FIG. 5 shows schematically three images of a bollard, which is another example of a safety structure; and

FIG. 6 shows an example embodiment of a method of detecting damage to a safety structure.

### DETAILED DESCRIPTION

Vehicle collisions can cause injury to persons, including the driver and pedestrians, and damage to structures and the vehicle itself. In a factory or warehouse environment, vehicles may be required to move within confined spaces and in close proximity to valuable goods and personnel. For example, in a warehouse, forklift trucks (FLTs) May pass between aisles of racking or shelving that contain valuable stock. A FLT may have to perform tight turns and manoeuvres to load and unload stock from the racking. Even a skilled driver may accidently collide with racking causing damage and creating a potential safety hazard from the racking collapsing, particularly if the collision is not detected or goes unreported.

Collision sensors on racking can alleviate this risk by detecting and reporting collisions. However, collision sensors may generate many false alarms from non-damaging collisions resulting from a pedestrian brushing past the structure, for example.

Similar hazards to those described above exist in other environments such as the airside of an airport terminal, a car park or a construction site, among others. The damage detection system disclosed herein may be suitable for use in any appropriate environment in which there is a benefit to identifying collisions with safety structures.

Examples disclosed herein relate to a damage detection system that processes one or more images in order to provide a damage-status-signal that represents a damage status of a safety structure. Beneficially, the images are acquired by a camera that is associated with a vehicle, such as forklift truck that is moving around a warehouse or another vehicle that moves in the vicinity of a safety structure that is to be monitored.

The damage detection system is for use with safety structures that are susceptible to damage, such as vehicle collisions. The safety structure may be a fixed structure, for example the system may be associated with posts, barriers, racking, walls, machine guarding, machine fencing etc within a warehouse environment. The damage detection system may also be used with safety structures such as bollards and barriers in an outdoor environment, including a construction site, a car park or an airport. The damage detection system may also be used with mobile safety structures that are susceptible to collisions, such as sliding racking, sliding barriers.

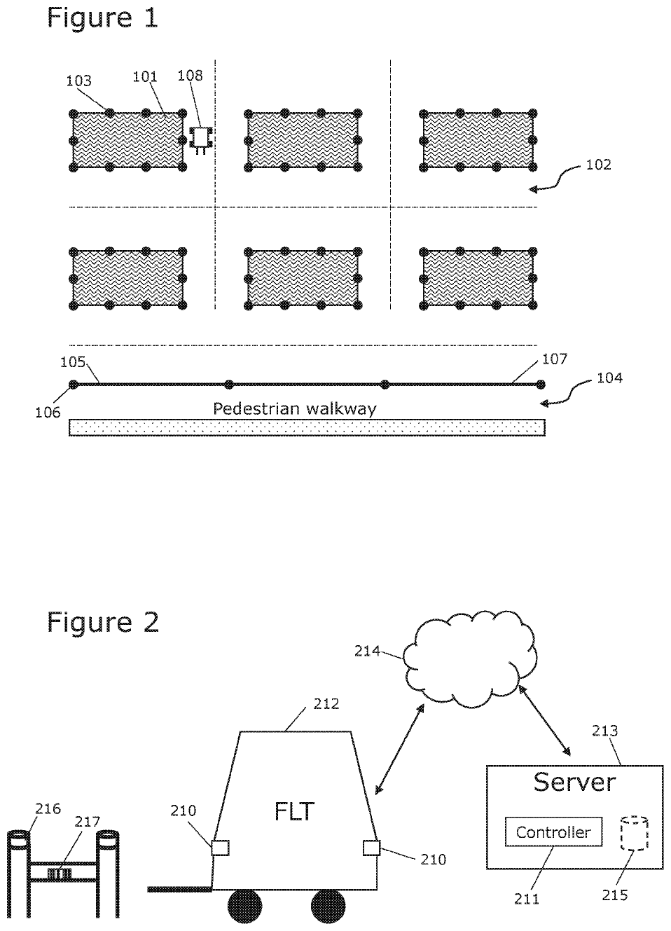

FIG. 1 shows schematically a plan view of part of the inside of a warehouse, which is a suitable environment in which a damage detection system that is described herein can be used. FIG. 1 shows six banks of racking 101, with aisles 102 in between each bank 101. As shown in FIG. 1, a forklift truck (FLT) 108 can drive along the aisles in order to access stock that is stored in different banks of racking 101. Each bank of racking 101 has a plurality of racking legs 103. A racking leg 103 is a vertical support that is used to support shelving or pallets. The banks of racking 101 can also include beams (that are generally horizontal) and/or braces (that extend generally diagonally with reference to the ground). Each of these components is an example of a safety structure that can be monitored by examples of the damage detection system that are described herein. A racking system in a warehouse can be considered as a safety structure in that it allows for storage of stock in a warehouse in a way that maintains the safety of the stock and any people or vehicles in the vicinity of the racking system.

FIG. 1 also shows that a part of the warehouse is designated as a pedestrian walkway 104. The pedestrian walkway 104 is separated from an end aisle of racking by a barrier 105. In this example, the barrier 105 is shown as including a plurality of spaced apart posts 106, with rails 107 joining the adjacent posts 106. The barrier 105 and/or components that are used to provide the barrier 105 are further examples of safety structures that can be monitored by embodiments of the damage detection system that are described herein. It will be appreciated that various different types of safety structure are relevant to the present disclosure. This includes, but is not limited to, a safety barrier, a safety bollard, a safety rail, a post for a safety rail, or a component part thereof.

FIG. 2 shows an example embodiment of a damage detection system. The damage detection system includes at least one camera 210, in this example two cameras 210 are visible in the drawing, and a controller 211 that processes the acquired images.

The cameras 210 are associated with a vehicle. In this example, the vehicle is a forklift truck (FLT) 212 such as one that is known to move stock around a warehouse. Although it will be appreciated that other types of vehicle can be used. The cameras 210 are configured to acquire images of the vicinity of the FLT 212. In this example, a safety barrier 216 (as an example of a safety structure) is shown in front of the FLT 212.

The controller 211 in this example is located on a server 213 that is remote from the FLT 212. The cameras 210 on the FLT 212 are in electronic communication with the server 213 over any network 214 that is known in the art, including the internet. However, in other examples some or all of the functionality of the controller 211 can be provided locally with the FLT 212.

The controller 211 processes the acquired images in order to recognise a safety structure in the image. Various examples of how a safety structure can be recognised are provided below, including the use of object recognition algorithms and machine learning algorithms. Once a safety structure has been recognised, the controller 211 can compare the recognised safety structure in the acquired image with an other image of the same, or a corresponding, safety structure. For instance, the recognised safety structure can be compared with an image of the same safety structure that was acquired earlier in time (i.e. the same safety structure) or with a stock image of the same type of safety structure (i.e. an image of a corresponding safety structure of the same type, but not exactly the same one). Then, based on the comparison, the controller 211 can provide a damage-status-signal that represents a damage status of the safety structure. Advantageously, such a damage detection system can automatically identify damage to a safety structure by simply processing images that are acquired as the vehicle (in this example a FLT) passes by the safety structure.

In some examples, the controller 211 recognises the safety structure in the image by performing an object recognition operation on the image. Such object recognition can include recognising edges in the image. In one example, the controller 211 may have access to memory 215 that includes data that represents one or more types of objects that are known safety structures. The data may represent the shapes of known safety structures. Therefore, the controller 211 can recognise one or more predetermined safety structures in the image by comparing objects that are recognised in the image with the data stored in memory 215.

Alternatively, the controller 211 may use a machine learning algorithm that has been trained on training data that includes images of safety structures. The controller 211 can apply the machine learning algorithm to the image in order to determine a classification of a safety structure, and thereby recognise a safety structure in the image.

As indicated above, the controller 211 compares the recognised safety structure in the image with an other image of the same, or a corresponding, safety structure as part of the damage detection operation. This can be performed in a number of ways, as set out below.

In one example, the controller 211 can determine an identifier for the type of safety structure that is recognised in the image. For instance, following recognition of the safety structure by object recognition (as discussed above), the controller 211 can simply retrieve form they memory an identifier that is associated with the safety structure that is matched to the one that is visible in the acquired image. Alternatively, if a machine learning algorithm is used, the determined classifier can be used as the identifier.

In another example, as shown in FIG. 2, the safety barrier 216 has a barcode 217 affixed to it. In this way, the controller 211 can determine an identifier for the type of safety structure that is recognised in the image by reading the barcode 217, or other type of machine-readable code that is visible in the image. It will be appreciated that other types of machine-readable code can be associated with the safety structure include a QR code or text. The identifier can be determined from the text by applying optical character recognition to the text in the image.

Once an identifier for the type of safety structure has been determined, the controller 211 can retrieve the other image of the same, or a corresponding, safety structure from memory 215. For example, the memory 215 may store a database or look-up table (LUT) that stores one or more images of the same, or a corresponding, safety structure associated with a unique identifier for the type of safety structure that has been recognised. In this way, the controller 211 can retrieve one or more images of the same type of safety structure from memory 215. The images may be of exactly the same safety structure, for example images of the safety structure that were acquired earlier in time as part of a previous damage detection operation when the FLT 212 passed by the safety structure, or as part of a calibration operation. Such a calibration operation may involve a vehicle driving past the safety structure when it is known to be undamaged (for instance shortly after installation) such that an image of the safety structure in an undamaged state can be stored in the memory 215. Alternatively, the images that are stored in memory 215 may be provided by the manufacturer of the safety structure such that they represent the intended appearance of the safety structure in an undamaged state. Furthermore, the images that are stored in memory may represent different views of the safety structure, for example from different angles and/or in different lighting conditions. Yet further, the images of the safety structure may include images of the safety structure in an undamaged state and/or one or more damaged states.

Once the image or images have been retrieved from memory, the controller 211 can compare the recognised safety structure in the acquired image with the one or more images of the same type of safety structure retrieved from memory in order to provide the damage-status-signal. If the controller 211 determines that there is a sufficient match (examples of how a degree of match can be determined are discussed below) between the recognised safety structure in the acquired image and a retrieved image that represents an undamaged safety structure, then the controller 211 can set the damage-status-signal such that it takes a value that represents “undamaged”. Similar processing can be performed for a retrieved image that represents a damaged safety structure such that the controller 211 can set the damage-status-signal such that it takes a value that represents “damaged”. As a further example, if the controller 211 determines that there is an insufficient match between the recognised safety structure in the acquired image and a retrieved image that represents an undamaged safety structure, then the controller 211 can determine if there is a sufficient match between the recognised safety structure in the acquired image and one or more retrieved images that represents a damaged safety structure. If there is a sufficient match, then the controller can set the damage-status-signal such that it takes a value that represents a particular type of damage that is represented by the image of the damaged safety structure (such as: “dented near base”, “dented near top”, “inclined at 10 degrees from the vertical”, etc.). The labels for such particular types of damage can be stored in the database/LUT in memory associated with the images of the damaged safety structure.

In one example, the machine-readable code directly represents the type of the safety structure. In another example, the machine-readable code represents a location of the safety structure. In which case, the controller 211 can determine the type of the safety structure by looking it up in a database or LUT that stores an association between each location and the type of safety structure that has been installed at that location.

Any description of comparing two images in this document can involve determining a degree of similarity between the images. Various examples of how to determine a degree of similarity between images are known in the art, and include template matching, calculation of cross-correlation between the images, feature detection in the images, etc., Image comparison may also comprise determining a coordinate transformation between the two images. Such a transformation may comprise determining the rotational and translational transformations based on the position and perspective of corresponding features in the images such as end-points or edges of the safety structure or the machine-readable code etc. When such an image comparison operation is used to determine the damage-status-signal, the damage-status-signal can be set such that is represents the damage status of the safety structure based on the similarity level. For instance, if the similarity level between an acquired image and an image of the same safety structure in an undamaged state is less than a threshold, then the damage-status-signal can be given a “damaged” value. If the similarity level is greater than a threshold, then the damage-status-signal can be given an “undamaged” value. As a further example, the controller 211 can set the damage-status-signal as a value that represents a degree of damage based on the similarity level—for instance, the controller can apply a mathematical operation to the determined similarity level to allocate a score between 0 and 10.

In a still further example, the controller 211 can compare the colour of the recognised safety structure in the acquired image with the colour of the safety structure in the other image. In this way, any rust that has developed on the safety structure can be identified. Therefore, if a colour change that corresponds to rust is determined by the comparison, the controller 211 can set the damage-status-signal to a value that represents whether or not the safety structure is rusted.

It will be appreciated that determining an identifier from the acquired image can also, or alternatively, be used by the controller 211 when it recognises the safety structure in the image in the first place. That is, the determination of an appropriate identifier can itself be considered as recognising that a safety structure is visible in the image.

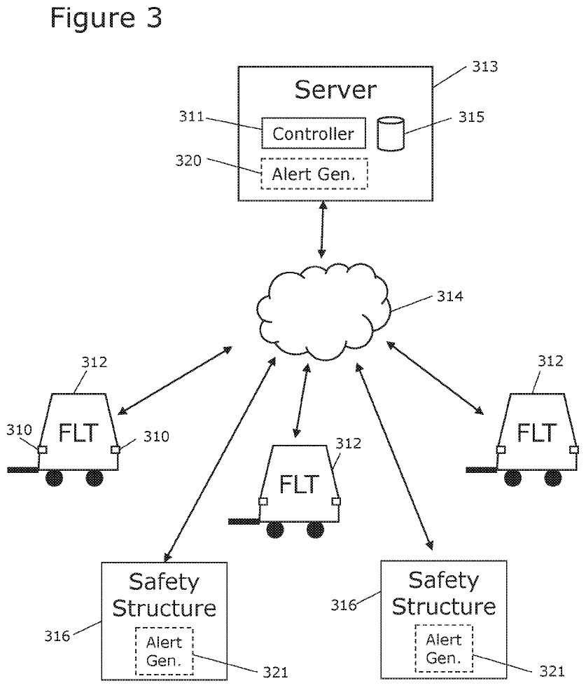

FIG. 3 shows another example embodiment of a damage detection system. In this example, the system includes three FLTs 312, each of which are in electronic communication with a server 313 over a network 314. The system also includes two safety structures 316, which are also in electronic communication with the server 313 over the network 314. It will be appreciated that there can be many more vehicles (which may or may not be FLTs) and safety structures in the system, and that only a modest number are shown in FIG. 3 to assist with the clarity of the illustration.

Each FLT 312 has at least one camera 310, in the same way as described with reference to FIG. 2.

In the example of FIG. 3, the server 313 and/or the safety structures 316 include optional alert signal generators 320, 321. The alert signal generators 320, 321 can selectively provide an alert based on the damage-status-signal that is calculated by the controller 311. For example, if the controller 311 sets the damage-status-signal to a value that represents a damaged state, then the controller 311 can activate an alert signal generator 320 associated with the server 313. The alert signal generator 320 can include an audible signal generator (such as a siren) and/or a visual signal generator (such as a flashing light), as non-limiting examples. The alert signal generator 320 can be located at any appropriate location, including in a control room of a warehouse, in a region of a warehouse in which the damage was detected, and on a vehicle that detected the damage. Also, the functionality of the alert signal generator 320 can be provided on a mobile communications device such as a smart phone that is running an associated application. As a further example, the alert signal generator 320 can provide a notification, such as an e-mail, that represents the detected damage. As a further example still, the alert signal generator 320 may cause a record of the detected damage to be written in electronic memory, such as by recording it in a log of detected damage events. The alert signal generator 320 may comprise a transmitter configured to transmit an alert signal to any external device to provide the functionality that is described herein.

In one or more of the above examples, providing the alert based on the damage-status-signal can include providing the acquired image. For example, a copy of the acquired image that shows the suspected damage can be provided with a notification. As set out above, such a notification can be sent to an operator over the internet or via a phone App. The notification can be sent to a person that is internal to a company that owns or runs a warehouse and/or it can be sent to the manufacturer of the racking/safety structure, as non-limiting examples.

In some examples, the controller 311 can determine the location of the safety structure that is recognised in the image. (As indicated above, some or all of the functionality of the controller 311 can be provided by components that are located on the vehicle/FLT 312.)

In one implementation, the FLT 312 can include location determining circuitry for determining a location of the FLT. Such location determining circuitry can include a Global Positioning System, GPS, (or another satellite navigation system), a Bluetooth Low Energy (BLE) beacon system, or any other location determining system that is known in the art. In some examples, the controller 311 can determine the location of the recognised safety structure by applying an offset to the location of the vehicle/FLT 312. The controller 311 can determine the offset based on the camera 310 that acquires the image and the direction of travel of the vehicle/FLT 312. In one example, the controller can identify one of a predetermined list of safety structures based on: an identifier of a camera that acquired the image, the direction of travel of the vehicle/FLT 312, the location of the vehicle/FLT 312, and optionally a map of locations of safety structures that are stored in memory 315. As a specific example, the following information can be used to unambiguously identify which of the plurality of locations of safety structures that are identified in the map has been recognised in the acquired image: the camera that acquired the image has a field of view directly to the left of the vehicle/FLT 312; the vehicle/FLT 312 was travelling north; and the vehicle/FLT 312 was in aisle 16 in warehouse 4 (as determined from a GPS on the vehicle/FLT 312).

In another implementation, the vehicle/FLT 312 may have a distance sensor (such as radar or a lidar) that can determine the distance to an object in a specific direction from the vehicle/FLT 312. In such an implementation, the controller 311 can determine the relative direction to the recognised safety structure by processing the acquired image and known directional information that represents the field of view of the camera that acquired the image with respect to a predetermined axis of the vehicle/FLT 312. Then, the controller 311 can determine the distance to the recognised safety structure using signalling received from the distance sensor and the relative direction determined from the acquired image. This can involve focusing a directional distance sensor in the determined relative direction towards the recognised safety structure, or extracting information from a multidirectional distance sensor that corresponds to the determined relative direction.

In another example, the controller 311 can determine the location of the safety structure by reading the location from a machine-readable code that is associated with the safety structure or is associated with a location of the environment in which the safety structure is located.

In examples where the location of the safety structure is determined, any alert that is provided by the alert signal generator 320 of the server 313 can also include the determined location. For instance, the location can be included in a notification, it can be included in a log, or it can be announced in a visual/audible alarm. Furthermore, the determined location of the safety structure that is damaged can be used to activate one or more alert signal generators that can be provided in the vicinity of the damaged safety structure, such alert signal generators can be provided as part of the infrastructure of the environment, for example.

If the safety structure 316 that has been identified as damaged includes an alert signal generator 321, then the controller 311 can activate that alert signal generator 321 to provide an alarm that is local to the damaged piece of safety structure 316. In this way, an alert signal generator can be used that provides an alert that is based on the determined location of the damaged safety structure.

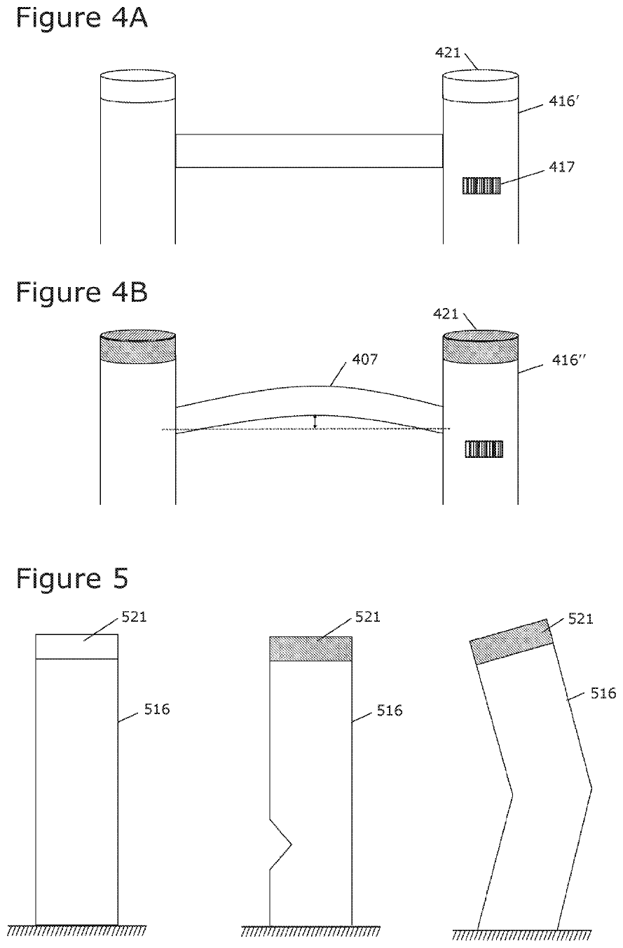

FIG. 4A shows schematically an image of an undamaged safety barrier 416′. The safety barrier 416′ includes a machine-readable code in the form of a barcode 417. Example uses of such machine-readable codes are described above. FIG. 4A also shows an example of an alert signal generator 421 in a deactivated state.

FIG. 4B shows schematically an image of a damaged safety barrier 416″, whereby a rail 405 of the barrier 416″ has been damaged and bent out of position. FIG. 4B shows schematically that the alert signal generator 421 provides a visual alert by being illuminated in response to the damage being detected.

FIG. 5 shows schematically three images of a bollard 516, which is another example of a safety structure. The bollard 516 also has an alert signal generator 521. In the left-hand image, the bollard 516 is undamaged and the alert signal generator 521 is deactivated. In the middle image, the bollard 516 is damaged in that a lower region of the bollard 516 is dented on one side. In the right-hand image, the bollard 516 is damaged in that an entire upper region of the bollard 516 is misaligned with the lower region of the bollard 516. The damage detection systems described herein are able to detect the damage that is visible in the middle and the right-hand images of FIG. 5. In the middle the right-hand images, the alert signal generator 521 has been activated in response to the detected damage.

Returning to FIG. 3, one or more of the vehicles/FLTs 312 include a plurality of cameras 310, each configured to acquire images of the vicinity of the vehicle/FLT 312. Optionally, each of the plurality of cameras 310 are located at potential impact points of the vehicle. For example, there may be four cameras 310: one each at the front, back and each side of the vehicle/FLT 312. As another example, a camera 310 could be located at or near each corner of the vehicle/FLT 312, or at any other potential impact point. At least two of the cameras 310 can have fields of view that are in different directions with respect to the vehicle/FLT 312. At least two of the cameras 310 can be mounted at different heights on the vehicle/FLT 312, or have fields of view that represent different heights with respect to the vehicle/FLT 312.

In some examples, the controller 311 combines a plurality of images of the same safety structure 316 into a combined-image. This can involve combining a plurality of 2-dimensional images that are acquired from different angles of the safety structure 316 to provide a 3-dimensional image of the safety structure 316. The controller 311 can then compare the combined-image with the other image of the same, or a corresponding, safety structure to provide the damage-status-signal. Beneficially, if the combined-image is a 3-dimensional image then a single comparison can be made to determine damage to any region of the safety structure, even if that damage is not visible in all of the 2-dimensional images. Such an example can include retrieving 3-dimensional images of an undamaged safety structure from a database for comparison with a 3-dimensional combined-image that is determined from 2-dimensional images that are acquired by the cameras 310 on the vehicle/FLT 312.

In another example, instead of creating a 3-dimensional combined-image, the controller 311 can process a sequence of acquired images to select one of the 2-dimensional images as the best matched perspective to the reference image. Then the controller can compare the selected image with the other image of the same, or a corresponding, safety structure to provide the damage-status-signal.

The plurality of images can be acquired by: the same camera 310 on the same vehicle/FLT 310 at different instants in time; different cameras 310 on the same vehicle/FLT 310 (at the same or different instants in time); or by cameras 310 on different vehicles/FLTs 310 (at the same or different instants in time).

In any of the examples described herein, the controller 311 can trigger the camera 310 to acquire an image for processing to recognise a safety structure in the image. Such a trigger can be:
periodic. For instance every 1, 5 or 10 seconds, or at any Interval that is considered appropriate for a particular application.
in response to the vehicle having a predetermined location. For instance, the controller 311 can compare the location of a vehicle/FLT 312 (e.g. as determined by any location determining system disclosed herein) with a plurality of predetermined locations that are associated with safety structures, such that images are acquired when a camera on the vehicle/FLT 312 is likely to have a safety structure in its field of view.
in response to receiving a proximity signal from a safety structure. For instance, a safety structure may have a proximity signal emitter that emits a signal that is received by a corresponding receiver on the vehicle/FLT 312 when it is in proximity with the safety structure 316.
in response to an on-demand command provided by a user. For instance a user, such as a driver of the vehicle/FLT 312, can provide an instruction to the damage detection system via a user interface to indicate that the camera 310 should acquire an image because it is likely to include a safety structure 316.

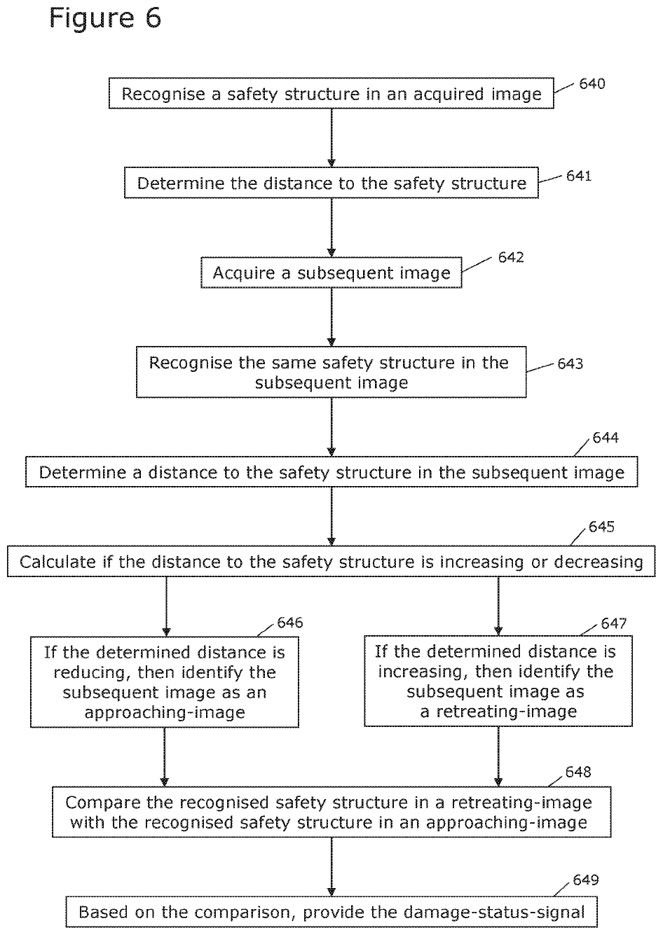

FIG. 6 shows an example embodiment of a method of detecting damage to a safety structure. As will be discussed below, the method incorporates some of the functionality that is described above.

At step 640, the method recognises a safety structure in an acquired image. As discussed above, the image is acquired by a camera that is associated with a vehicle (such as FLT) that is in the vicinity of the safety structure. If an image is acquired that does not include a safety structure, then the method of FIG. 6 is not performed.

At step 641, the method determines the distance to the safety structure that is recognised in the acquired image. This distance can be determined in any of the ways described herein, including: use of a distance sensor (such as a radar or a lidar); use of a GPS on the vehicle and a map of known locations of safety structures, and reading of a machine-readable code.

At steps 642 and 643 the method acquires a subsequent image and recognises the same safety structure in the subsequent image. It will be appreciated that steps 642 and 643, and the steps that follow, can repeated for any number of subsequent images that show the same safety structure.

At step 644, the method determines a distance to the safety structure in the subsequent image. Again, this distance can be determined using any of the principles disclosed herein or otherwise known in the art.

At step 645, the method calculates if the distance to the safety structure is increasing or decreasing. That is, is the vehicle approaching the safety structure, or moving away from it. If the determined distance is reducing, then at step 646 the method identifies the subsequent image as an approaching-image. If the determined distance is increasing, then at step 647 the identifies the subsequent image as a retreating-image.

At step 648, the method compares the recognised safety structure in a retreating-image with the recognised safety structure in an approaching-image. Then at step 649, based on the comparison, the method provides the damage-status-signal that represents the damage-status of the safety structure. The method can set the damage-status-signal to a “damaged” value if there is a sufficient difference between the two images. It can be advantageous to compare a retreating-image with an approaching-image in order to promptly detect damage to the safety structure by the vehicle. That is, the damage can be detected very shortly after the vehicle moves away from the safety structure following an impact. Furthermore, prompt feedback can be provided to the driver of the vehicle such that they can learn from the impact which will reduce the likelihood of damage being inflicted on safety structures in the future.

1. A damage detection system, comprising:
a camera associated with a vehicle, wherein the camera is configured to acquire images of a vicinity of the vehicle; and
a controller configured to process the acquired images in order to:
recognise a safety structure in the acquired images;
compare the recognised safety structure in the acquired image with an other image of the same, or a corresponding, safety structure; and
based on the comparison, provide a damage-status-signal that represents a damage status of the safety structure.

2. The system of claim 1, wherein the vehicle is a forklift truck.

3. The system of claim 1, further comprising a plurality of cameras, each configured to acquire images of the vicinity of the vehicle.

4. The system of claim 1, wherein the controller is configured to recognise the safety structure in the image by:
performing an object recognition operation on the image in order to recognise one or more predetermined safety structures in the image; or
applying a machine learning algorithm to the image in order to determine a classification of a safety structure as one that was visible in an image that was used as training data for training the machine learning algorithm.

5. The system of claim 1, wherein the controller is configured to compare the recognised safety structure in the image with the other image of the same, or a corresponding, safety structure by:
determining an identifier for a type of safety structure that is recognised in the image;
retrieving one or more images of the same type of safety structure from a memory; and
comparing the recognised safety structure in the image with the one or more images of the same type of safety structure retrieved from the memory.

6. The system of claim 5, wherein the one or more images of the same type of safety structure retrieved from the memory comprise images of the safety structure in an undamaged state and/or one or more damaged states.

7. The system of claim 5, wherein:
comparing the recognised safety structure in the image with the one or more images of the same type of safety structure retrieved from the memory comprises determining a degree of similarity between the images; and
the controller is configured to provide the damage-status-signal, that represents the damage status of the safety structure, based on the determined degree of similarity.

8. The system of claim 5, wherein the controller is configured to determine the identifier for the type of safety structure that is recognised in the image by reading a machine-readable code that is visible in the acquired image.

9. The system of claim 1, wherein the controller is configured to:
combine a plurality of images of the same safety structure into a combined-image; and
compare the combined-image with the other image of the same, or a corresponding, safety structure.

10. The system of claim 9, wherein the controller is configured to:
combine the plurality of images of the same safety structure into a 3-dimensional combined-image.

11. The system of claim 1, wherein the controller is configured to:
determine the distance to the safety structure that is recognised in the image;
in response to the acquisition of subsequent images by the camera:
recognise the safety structure in the subsequent image;
determine a distance to the safety structure in the subsequent image;
calculate if the distance to the safety structure is increasing or decreasing, and:
if the determined distance is reducing, then identify the subsequent image as an approaching-image; and
if the determined distance is increasing, then identify the subsequent image as a retreating-image;
compare the recognised safety structure in a retreating-image with the recognised safety structure in an approaching-image; and
based on the comparison, provide the damage-status-signal that represents the damage-status of the safety structure.

12. The system of claim 1, further comprising an alert signal generator that is configured to selectively provide an alert based on the damage-status-signal.

13. The system of claim 12, wherein the controller is configured to:
determine a location of the safety structure that is recognised in the image; and
provide an alert that is based on the determined location of the safety structure.

14. The system of claim 1, wherein the controller is configured to trigger the camera to acquire the image:
periodically;
in response to the vehicle having a predetermined location;
in response to receiving a proximity signal from a safety structure; and/or
in response to an on-demand command provided by a user.

15. The system of claim 1, wherein the controller is configured to:
compare a colour of the recognised safety structure in the acquired image with a colour of the safety structure in the other image of the same, or a corresponding, safety structure; and
based on the comparison, provide a damage-status-signal that represents whether or not the safety structure is rusted.

16. A controller for a damage detection system, wherein the controller is configured to:
process images that are acquired by a camera associated with a vehicle;
recognise a safety structure in the acquired images;
compare the recognised safety structure in the acquired image with an other image of the same, or a corresponding, safety structure; and
based on the comparison, provide a damage-status-signal that represents a damage status of the safety structure.

17. A method of detecting damage to a safety structure, the method comprising:
acquiring images of a vicinity of a vehicle;
recognising a safety structure in the acquired images;
comparing the recognised safety structure in the acquired image with an other image of the same, or a corresponding, safety structure; and
based on the comparison, providing a damage-status-signal that represents a damage status of the safety structure.
